(19) United States
(12) Patent Application Publication
(10) Pub. No.: US 2018/0104142 A1
(43) Pub. Date: Apr. 19, 2018

(54) PHYSICAL THERAPY METHOD AND DEVICE SUITABLE THEREFOR

(71) Applicants: Morse Assaly, Kafr Qara (IL); Gabriel Teperberg, Kfar Saba (IL)

(72) Inventors: Morse Assaly, Kafr Qara (IL); Gabriel Teperberg, Kfar Saba (IL)

(21) Appl. No.: 15/694,879

(22) Filed: Sep. 4, 2017

(30) Foreign Application Priority Data
Sep. 6, 2016 (GB) 1615138.3

(51) Int. Cl. A61H 33/00; A63B 71/10

(52) U.S. Cl. CPC A61H 33/0087; A61H 33/6021; A63B 71/10

(57) ABSTRACT

Disclosed is a hydrotherapy method suitable for diagnosis and treatment of a subject, as well as headgear suitable for use during hydrotherapy diagnosis and treatment.

### RELATED APPLICATION

The instant application claims priority under 35 U.S.C. 119 of UK patent application GB 1615138.3 filed on Sep. 6, 2016 and which is included by reference as if fully set-forth herein.

### FIELD AND BACKGROUND OF THE INVENTION

The invention, in some embodiments, relates to the field of physical therapy, and more particularly, but not exclusively, to methods and devices useful for improving physical function of human in need thereof.

Physical therapy is a paramedical profession which aim is to improve quality of life of a subject suffering from musculoskeletal or neurological disorder by direct physical manipulation of the musculoskeletal system to reduce pain and improve mobility of the subject One particularly effective form of physical therapy is hydrotherapy, where the physical manipulation of the musculoskeletal system is performed while the subject is at least partially immersed in water, for example, a swimming pool. The buoyancy (that reduces the stress and strain on the bodily joints), temperature control (that increases blood flow) and physical contact (that acts as an analgesic) provided by the water to the subject has been found to increase the efficacy of the treatment.

It would be valuable to have methods and devices that increase the types and/or efficacy of hydrotherapeutic treatments available for treating subjects in need thereof.

### SUMMARY OF THE INVENTION

Aspects of the inventions disclosed herein herein relate to methods and devices useful in the field of hydrotherapy, for example, for rehabilitation of a human suffering from a cervical disorder.

According to an aspect of some embodiments of the teachings herein, there is provided a method for hydrotherapeutic treatment of a human subject in need thereof, the human subject wearing headgear, comprising:

while the head of the subject is at least partially immersed in water,
a. maintaining the nose and mouth of the subject outside of the water to a degree allowing breathing; and
b. moving the head of the subject to effect diagnosis and therapy of the neck of the subject,
   wherein the moving of the head is by a treating person who moves the head through the headgear.

According to an aspect of some embodiments of the teachings herein, there is also provided a method of performing hydrotherapy on a human subject in need thereof, comprising:
a. immersing at least part of the body of a human subject in water; and
b. while the at least part of the body is immersed in the water, moving the head of the subject while an artificial free weight is affixed to the head in a fixed asymmetric distribution.

As detailed hereinbelow, embodiments of the method where the moving of the head of a subject is by a treating person who moves the head through headgear may have one or more different additional features. As discussed in detail hereinbelow, some embodiments of this method are typically implemented at the beginning of a course of treatment of a subject, inter alia, for diagnosis of the problem that causes the subject pain, for reduction of the pain to tolerable levels and to increase the range of motion.

As detailed hereinbelow, embodiments of the method where the moving of the head of a subject while an artificial weight is affixed to the head in a fixed asymmetric distribution may have one or more different additional features. As discussed in detail hereinbelow, some embodiments of this method are typically implemented subsequent to the diagnosis and pain reduction, for example, using the method where the moving of the head of a subject is by a treating person who moves the head through headgear, primarily during a period to maintain the gains made (e.g., reduced pain increased range of motion) and to arrest any degeneration.

Although not extensively discussed herein for the sake of brevity and clarity, typically the two methods are used serially as part of the same treatment concept: first reducing pain and increasing the range of motion, and subsequently strengthening the muscles (especially of the neck and shoulders). Since pain reduction and increasing the range of motion is performed first, subsequent training with the weight fixed to the head is done better.

According to an aspect of some embodiments of the teaching herein, there is provided headgear suitable for use in hydrotherapy, comprising:
a head encircler configured to encircle the head of a human around the skull;
a chin strap functionally associated with the head encircler, configured to encircle the head of a human underneath the chin,
   the head encircler and chin strap together configured to immovably secure the headgear to the head of a human wearer, and
   the headgear configured for substantially immovable support of an attached free weight of at least 100 g through at least one attachment locus at at least four quadrant positions of the transverse plane of the headgear one at a time:
i. a front position where the center of mass of the attached weight is located towards the front of the headgear in a direction within 30° of the 0° direction of the transverse plane;
ii. a right position where the center of mass of the attached weight is located towards the right of the headgear in a direction within 30° of the 90° direction of the transverse plane;
iii. a back position where the center of mass of the attached weight is located towards the back of the headgear in a direction within 30° of the 180° direction of the transverse plane; and
iv. a left position where the center of mass of the attached weight is located towards the left of the headgear in a direction within 30° of the 270° direction of the transverse plane.

According to an aspect of some embodiments of the teaching herein, there is also provided headgear suitable for use in hydrotherapy diagnosis and treatment, comprising:
a head encircler configured to encircle the head of a human around the skull;
a chin strap functionally associated with the head encircler, configured to encircle the head of a human underneath the chin,
   the head encircler and chin strap together configured to immovably secure the headgear to the head of a human wearer, and
   functionally associated with the head encircler, one or both of:
at least two handles, each located on a different one of the two sides of the headgear,
configured for engagement by the hands of a human located along the vertical axis of the headgear; and
a shell, functionally associated with the head encircler, configured to at least partially surround the skull of a human wearing the headgear, with a slip resistant area on each one of the two sides of the shell, a slip resistant area configured for non-sliding contact with a naked human hand when wet.

As detailed hereinbelow, embodiments of the headgear according to the teachings herein configured for substantially immovable support of an attached free weight may have one or more different additional features.

Also as detailed hereinbelow, embodiments of the headgear according to the teachings herein having one or both of: at least two handles; and a shell with a slip resistant area may have one or more different additional features.

Although not extensively depicted herein for the sake of brevity and clarity, some embodiments of the headgear according to the teachings herein are configured for substantially immovable support of an attached free weight and have one or both of: at least two handles; and a shell with a slip resistant area. Some such embodiments additional include on or more of the additional features discussed herein in detail with reference to the configuration for substantially immovable support of an attached free weight as well as one or more of the additional features discussed herein in detail with reference to having one or both of: at least two handles; and a shell with a slip resistant area.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale. In the Figures:

FIGS. 1A and 1B are schematic depictions of a first exemplary embodiment of headgear useful for diagnosis and pain reduction according to the teachings herein, in perspective (FIG. 1A) and top view (FIG. 1B);

FIG. 2 is a schematic depiction of implementation an embodiment of a method according to the teachings herein by use of the headgear depicted in FIGS. 1;

FIGS. 3A and 3B are schematic depictions of a second exemplary embodiment of headgear useful for diagnosis and pain reduction according to the teachings herein, in perspective (FIG. 3A) and cross section from the top (FIG. 3B);

FIG. 4 is a schematic depiction of a third exemplary embodiment of headgear useful for diagnosis and pain reduction according to the teachings herein in cross section from the top;

FIG. 5 is a schematic depiction of a fourth exemplary embodiment of headgear useful for diagnosis and pain reduction according to the teachings herein, in perspective;

FIG. 6 is a a top view of a human head showing directions of the transverse plane;

FIGS. 7A and 7B are schematic depictions of a first exemplary embodiment of headgear with an attached weight according to the teachings herein, in perspective (FIG. 7A) and cross section from the top (FIG. 7B);

FIGS. 8A and 8B are schematic depictions of a second exemplary embodiment of headgear with an attached weight according to the teachings herein, in perspective (FIG. 8A) and cross section from the top (FIG. 8B);

FIGS. 9A and 9B are schematic depictions of a third exemplary embodiment of headgear with an attached weight according to the teachings herein, in perspective (FIG. 9A) and cross section from the top (FIG. 9B); and

FIGS. 10A, 10B and 10C are schematic depictions of a fourth exemplary embodiment of headgear with an attached weight according to the teachings herein, in perspective (FIG. 10A) and cross section from the top (FIGS. 10B and 10C).

### DESCRIPTION OF SOME EMBODIMENTS OF THE INVENTION

Aspects of the inventions disclosed herein herein relate to methods and devices useful in the field of hydrotherapy, for example, for rehabilitation of a human suffering from a cervical disorder.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

Herein are taught methods and devices useful in the field of hydrotherapy. In some embodiments, the methods and devices allow for more effective and/or efficient diagnosis, pain reduction (as used herein, synonymous with pain mitigation) and long-term increase of mobility of a human subject, for example, of a human suffering from a cervical disorder.

A person suffering from a cervical disorder may suffer from chronic pain in the neck or chronic pain when the neck is moved to a certain position. Conscious and unconscious changes in movement and posture adopted by the person to reduce the extent or to avoid the pain not only reduce the person's mobility and quality of life, but may also lead to projection of the pain to other portions of the body and/or to degeneration of muscles and/or joints in the neck as well as other parts of the body, that in turn leads to further pain and degeneration.

Such a person often undergoes hydrotherapeutic therapy first to mitigate the pain in order to arrest further degeneration, followed by an attempt to maintain and, if possible, increase, the range of motion of the various joints including of the neck thereby maintaining and hopefully increasing the person's quality of life.

### Diagnosis and Pain Reduction

One of the first steps for a person suffering cervical pain and undergoing hydrotherapy is diagnosis and pain reduction. In a number of sessions (typically 1-2 sessions a week over a period of 4-8 weeks, each session typically 15-45 minutes) a hydrotherapist performs diagnosis (to determine the pain-free range of motion of the neck and other parts of the body, allowing the hydrotherapist to formulate a treatment schedule) and attempts to mitigate the pain by repetitive specific movement of the joints and other body parts of the person by the hydrotherapist.

Specifically, the person is at least partially immersed in water so that the head of the person is immersed face-up in water with nose and mouth outside of the water. Preferably, the person is made to float laying on the back, if necessary with the help of an artificial flotation device, typically one or more flotation noodles placed underneath the ankles and/or knees and/or small of the back and/or armpits.

While the head of the person is immersed as above, the hydrotherapist may press along the spine, especially the cervical spine, to evaluate the muscle tone and identify whether such pressing causes pain to the person.

Additionally, while the person is floating on the back and while ensuring that the person's face does not become submerged, the hydrotherapist moves parts of the person's body to identify the tone of the different muscles, identify what the range of motion of the joints are and whether the joints are underflexed or overflexed.

Such moving may include moving the arms, especially at the shoulder.

Such moving may include moving the neck by holding the head with both hands at or just above the ears and then, one or more of: rotation of the head (left and right) around the cervical axis in the transverse plane (e.g., like shaking the head);sagittal flexion the neck, a tilting of the head by bending the neck back and forth in the sagittal plane (e.g., like nodding the head); side flexion of the neck, a tilting of the head (left and right flexion) by bending the neck left and right in the frontal plane (e.g., like bobbling the head); and
pulling the head in the vertical axis to pull the cervical spine along the vertical axis, in some instances, leading to dragging the person through the water by the head.

When performed by a skilled hydrotherapist, such pulling and/or moving of the neck separates the cervical vertebrae and reduces muscle tone. Such separation of the vertebrae and reduction of muscle tone causes an increased inflow of nutrients and oxygen to the different tissues in the cervical region, increased outflow of toxins, increases the range of motion of the neck, and markedly mitigates pain.

It is important to note that in some instances, a person being treated is not allowed to lay down for a medical reason, for example, having high blood pressure. In such instances, the above movements may be performed while the person is immersed in water as described above while sitting back in a chair or laying on a couch in the water, preferably with the head immersed face-up in the water with mouth and nose outside of the water.

Typically, the positive effects of a given session that includes movement of the neck as described above last for not more than about two days, after which the pain progressively returns and the limitation of the range of motion returns. That said, typically after ten sessions there is a marked reduction in pain, increased range of motion, reduction in muscle tone, and a reduced incidence of pain projection to other parts of the body.

The efficacy of the hydrotherapeutic treatment described above in terms of the extent and duration of positive effects is primarily determined by the skill of the individual hydrotherapist and depends, inter alia, on the order in which movements are done, the extent of any given movement and the number, as well as the rate, of repetitions.

The Inventor has found and herein discloses that improved results of such hydrotherapeutic treatment can often be achieved when the movement of the head is performed while the person undergoing treatment (a subject) wears headgear, and the hydrotherapist moves the head while holding the headgear. Although not wishing to be held to any one theory, it is currently believed that this improvement is attributable to greater leverage afforded by the headgear and/or a greater degree of control that the headgear provides the hydrotherapist.

### Method and Headgear Useful for Diagnosis and Pain Reduction

According to an aspect of some embodiments of the teachings herein, there is provided a method for hydrotherapeutic treatment of a human subject in need thereof, the human subject wearing headgear, comprising:

while the head of the subject is at least partially immersed in water,
a. maintaining the nose and mouth of the subject outside of the water to a degree allowing breathing; and
b. moving the head of the subject to effect diagnosis and therapy of the neck of the subject,
   wherein the moving of the head is by a treating person who moves the head through the headgear.

In some embodiments, the method is performed while the head of the subject is at least partially immersed face-up (in some embodiments, laying down, that is to say, laying face-down) in water with nose and mouth outside of the water

In some embodiments, the method comprises maintaining the nose and mouth of the subject outside of the water continuously, e.g., the subject is laying in the water and the nose and mouth are not immersed. That said, in some embodiments, the method comprises maintaining the nose and mouth of the subject outside of the water intermittently, e.g., the subject's face is allowed to go underwater while the head is rotated, and/or the subject's face is allowed to go underwater while the head and body are rotated and/or the subject is laying face down in the water and intermittently the head is rotated to allow breathing.

In some embodiments, the need of the subject arises from pain, in some embodiments, in the cervical spine. In some embodiments, the need of the subject arises from a musculoskeletal disorder, in some embodiments, of the cervical spine. In some embodiments, the musculoskeletal disorder is selected from the group consisting of: cervical disk lesion, cervical disk protrusion, cervical pain, cervical spine fracture, disk herniation, inflammation of neck muscles and/or tendons, limitation of range of motion of the neck, musculoskeletal degeneration, spinal stenosis, spondylosis, torticollus, weakness in neck muscles (e.g., sternocleidomastoid) and whiplash. In some embodiments, the need of the subject arises from the need for post-operative recovery.

In some embodiments, the method comprises, prior to the moving of the head, securing the headgear to the head of the subject.

In some embodiments, the treating person is a health-care professional, in some embodiments a physical therapist (especially a hydrotherapist or physical therapist assistant (especially a hydrotherapist assistant).

In some embodiments, during the immersion, the subject is laying face-up in the water.

In some embodiments, during the immersion, the subject is laying on the side in the water.

In some embodiments, during the immersion, the subject is laying face-down in the water. In such embodiments, a treating person typically ensures that the subject can breathe by intermittent rotation and/or sagittal flexion of the head, sufficient to allow breathing.

In some embodiments, during the immersion, the subject is floating in the water. In some embodiments, the subject is functionally associated with a flotation aid (e.g., flotation vest, flotation noodle). In some embodiments, the method comprises, prior to the moving of the head, functionally associating the subject with a flotation aid.

In some embodiments, while the subject is immersed in the water, the method further comprises supporting the subject to ensure that the nose and mouth do not submerge in the water.

In some such embodiments, support is afforded by a person different than the subject (e.g., a health-care professional) supporting the subject from below. In some such embodiments, support is afforded by a flotation aid.

The moving of the head of the subject to effect diagnosis and therapy of the neck of the subject is any suitable movement.

As noted above, the moving of the head is by a treating person who moves the head through the headgear, that is to say, the treating person applies the force that moves the head through the headgear by contacting the headgear with one or two hands of the treating person.

In some embodiments, the moving of the head of the subject is at least one of:
i. rotating the head of the subject (as noted above, rotation of the head around the cervical axis in the transverse plane);
ii. sagittal flexion of the neck of the subject (as noted above, tilting the head by bending the neck back and forth in the sagittal plane);
iii. side flexion of the neck of the subject (tilting the head by bending the neck left and right in the frontal plane);
iv. pulling the head of the subject in the vertical axis. In some embodiments, the pulling of the head in the vertical axis drags the subject through the water; and
v. combinations (in some embodiments, simultaneous combinations) of i, ii, iii and iv, for example side flexion and rotation, simultaneously or serially.

In some embodiments, rotation includes 360° of the head of the subject, that leads to 360° rotation of the entire body of the subject.

The method above may be implemented using any suitable headgear. That said, in some embodiments it is preferred to use a headgear according to the teachings herein.

According to an aspect of some embodiments of the teaching herein, there is provided headgear suitable for use in hydrotherapy diagnosis and treatment, comprising:
a head encircler configured to encircle the head of a human around the skull;
a chin strap functionally associated with the head encircler, configured to encircle the head of a human underneath the chin,
   the head encircler and chin strap together configured to immovably secure the headgear to the head of a human wearer, and
   functionally associated with the head encircler, one or both of:
at least two handles, each located on a different one of the two sides of the headgear, configured for engagement by the hands of a human located along the vertical axis of the headgear; and
a shell, functionally associated with the head encircler, configured to at least partially surround the skull of a human wearing the headgear, with a slip resistant area on each one of the two sides of the shell, a slip resistant area configured for non-sliding contact with a naked human hand when wet.

By “immovably secure the headgear to the head of a human wearer” is intended that when secured to the head of a human, the headgear and the head move together even with sudden movements or application of force.

The vertical axis of any headgear is an imaginary line that coincides with the vertical axis of the head of the wearer of the headgear.

Preferably, the headgear is waterproof, that is to say, is fashioned in a manner and of materials that are not damaged by prolonged contact with water; do not absorb water and do not change shape or dimensions when immersed in water.

In some embodiments, the density and dimensions of the headgear are such so as to apply no or only insubstantial force to the head of a wearer when immersed in water, thereby avoiding damage to the neck (e.g., upwards force caused by positive buoyancy, or downwards force caused by negative buoyancy).

In some embodiments, the headgear has a density of between 0.97 and 1.03 g/ml. When worn by a person whose head is immersed in water, such embodiments of the headgear apply only insubstantial force to the head of a wearer, especially when the headgear is of modest dimensions.

In some embodiments, the headgear has neutral buoyancy at the surface of at least one of swimming pool water, fresh water and sea water.

Components of some embodiments of the invention are fashioned of buoyant materials such as foams due to the ease with which such materials can be fashioned into headgear, availability and water-proof properties. In order to ensure that such headgear has the required density or buoyancy so as to apply no or only insubstantial force to the head of a wearer when immersed in water, in some embodiments the headgear further comprises a weighting components having a density greater than that of water distributed so that the headgear has the desired buoyancy or density. Such weighting components are typically fashioned of sheets, plates or pellets of a material such as a metal (e.g., aluminum, lead, steel) or a ceramic. The distribution of the weighting component on the headgear, is preferably such to produce no substantial torque on the head of a person wearing the headgear when the person is floating face-up in water.

In some embodiments, a head encircler has a fixed diameter, e.g., a foamed-plastic headgear crown portion or a fixed diameter headband. In some embodiments, a head encircler is flexible, e.g., a flexible headband. In some embodiments, a head encircler has an adjustable diameter to fit on different sized/shaped human heads, e.g., is an adjustable headband. In some embodiments, a head encircler is elastically stretchable, allowing stretching and contracting to fit around a head of a wearer. That said, in some embodiments, a head encircler is not stretchable. In some embodiments, a head encircler is a continuous headband. In some embodiments, the head encircler is a discontinuous headband configured to be opened and closed (e.g., with a hook and loop fastener or a buckle).

In some embodiments, a chinstrap has an adjustable diameter to fit on different sized/shaped human heads. In some embodiments, a chinstrap is elastically stretchable, allowing stretching and contracting to fit around a chin of a wearer. In some embodiments, a chinstrap is not-stretchable. In some embodiments, a chinstrap is a continuous band. In some embodiments, a chinstrap is a discontinuous band configured to be opened and closed (e.g., with a hook and loop fastener or a buckle).

In some embodiments, the headgear is configured to leave the cervical spine (c1-c7) of a wearer free of obstruction, sufficient to allow a health-care professional (such as a hydrotherapist) access to the cervical spine.

If when worn the headgear protrudes relatively far from the back of the head, the protrusion potentially interferes with manipulation of the head of a wearer by a health-care professional. Accordingly, in some embodiments, the back of the headgear protrudes by not more than 5 cm, not more than 4 cm and even not more than 3 cm from the inner surface of the headband (and therefore from the back of the head of a wearer).

### Handles

As noted above, in some embodiments, headgear according to the teachings herein comprises at least two handles, each one of the two handles located on a different one of the two side of the headgear, configured for engagement by the hands of a human located along the vertical axis of the headgear. Such handles allow a treating person standing in the water at the head of the subject near the vertical axis of the headgear (and head of the subject) to easily move the head of the subject by holding the handles with the hands.

In some embodiments, the handles are detachable from the headgear. In some embodiments, the handles are not detachable from the headgear.

The length of the handles is any suitable length, in some embodiments not less than 5 cm long, and even not less than 10 cm long.

In some embodiments, the handles are directly physically connected to the head encircler. In some embodiments, the handles are functionally associated with the head encircler through an intervening physical feature such as an outer shell.

In some embodiments, the handles are elongated protrusions, substantially perpendicular to the vertical axis of the headgear. In such embodiments, the handles protrude from the headgear by any suitable distance, in some embodiments by not less than 1 cm and not more than 20 cm. In some embodiments, the handles protrude from the headgear by not less than 3 cm and even by not less than 4 cm. In some embodiments, the handles protrude from the headgear by not more than 15 cm and even by not more than 10 cm.

In some embodiments, the headgear further comprises a shell, functionally associated with the head encircler, configured to at least partially surround the skull of a human wearing the headgear. In some such embodiments, the handles are elongated protrusions, substantially perpendicular to the vertical axis of the headgear attached to the shell. In some such embodiments, the handles are elongated slits in the shell, having a width allowing insertion of fingers therein.

### Slip-Resistant Areas

As noted above, in some embodiments, headgear according to the teachings herein comprises a shell, functionally associated with the head encircler, configured to at least partially surround the skull of a human wearing the headgear, with a slip-resistant area on each one of the two sides of the headgear, the slip-resistant area configured for non-sliding contact with a naked human hand when wet.

The size of the slip-resistant areas is any suitable size. In some embodiments, on each side of the headgear, there is a slip resistant area of not less than 20 cm², not less than 30 cm², and even not less than 40 cm².

Such slip resistant areas allow a treating person standing in the water at the head of the subject near the vertical axis of the headgear (and head of the subject) to easily move the head of the subject by contacting the slip-resistant areas with the hands.

In some embodiments, there is a continuous slip-resistant area that reaches both sides of the headgear. In some embodiments, there are separate slip-resistant areas on each side of the headgear separated by a non-slip resistant area. For example, in some embodiments, the shell is made of a smooth polycarbonate, with two textured rubber panels on either side as slip-resistant areas.

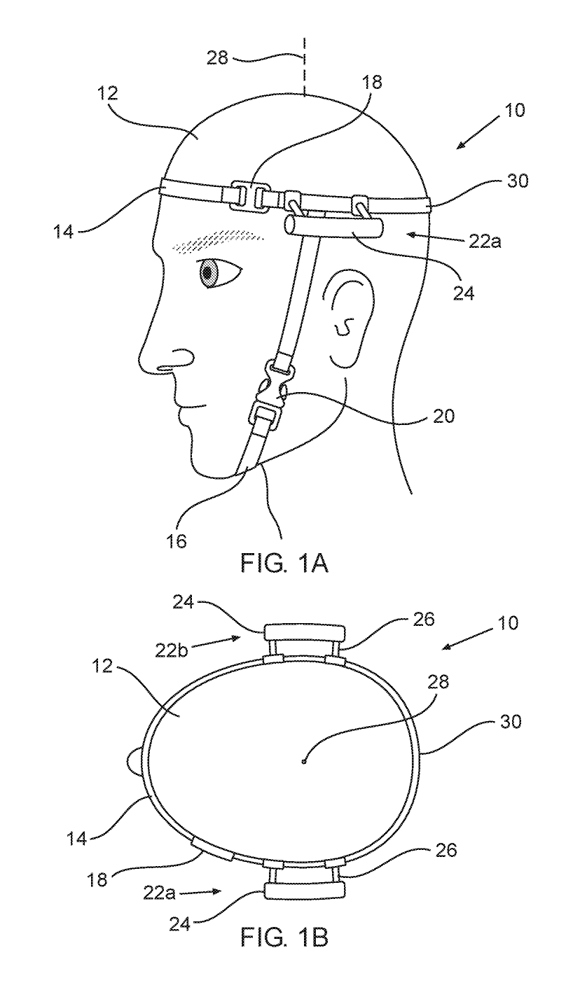

An embodiment of headgear 10 according to the teachings herein is schematically depicted in FIGS. 1 in side view (FIG. 1A) and top view (FIG. 1B) worn on the head 12 of a subject. Headgear 10 comprises, as a head encircler, a headband 14 encircling head 12, a chin strap 16 functionally associated with headband 14 encircling head 12 underneath the chin, both made of non-water absorbent not elastic ultra-high molecular weight polyethylene (UHMWPE) webbing (3 mm thick). Headband 14 is a continuous band which diameter is adjustable using a high-density polyethylene strap-adjuster slide 18. Chin strap 16 is a discontinuous band that can be opened and closed, using a quick-release plastic buckle 20 with integrated strap-adjuster slide functionality, allowing adjustment of the diameter of chin strap 16. When secured to the head with the diameters of headband 14 and chin strap 16 properly adjusted, headgear 10 is immovably secured to head 12.

On either side of headgear 10 is a handle 22a (on the left side) and 22b (on the right side). Each handle 22 is an elongated protrusion fashioned of a single piece of high-density polyethylene, comprising a 12 cm long rod 24 secured to headband 14 through integrally formed legs 26 that are connected to headband 14 by clipping over the sides of headband 14. Handles 22 are detachable from headgear 10. Rods 24 are perpendicular to a vertical axis 28 of headgear 10, thereby configured for engagement by the hands of a human located along vertical axis 28 of headgear 10.

The back 30 of headgear 10 is substantially the back portion of headband 14, thereby leaving the cervical spine of a wearer accessible and free of obstruction. Additionally, back 30 of headgear 10 thereby protrudes by not more than the thickness of headband 14, i.e., 3 mm.

Headgear 10 is fashioned of polyethylene (0.97 g/ml) and is therefore waterproof. Due to the modest dimensions of headgear 10, when worn by a person whose head is immersed in water, headgear 10 applies substantially no upwards force to the head of a wearer, even in salt water. At the same time, headgear 10 inherently floats on the surface of water, easing use in water.

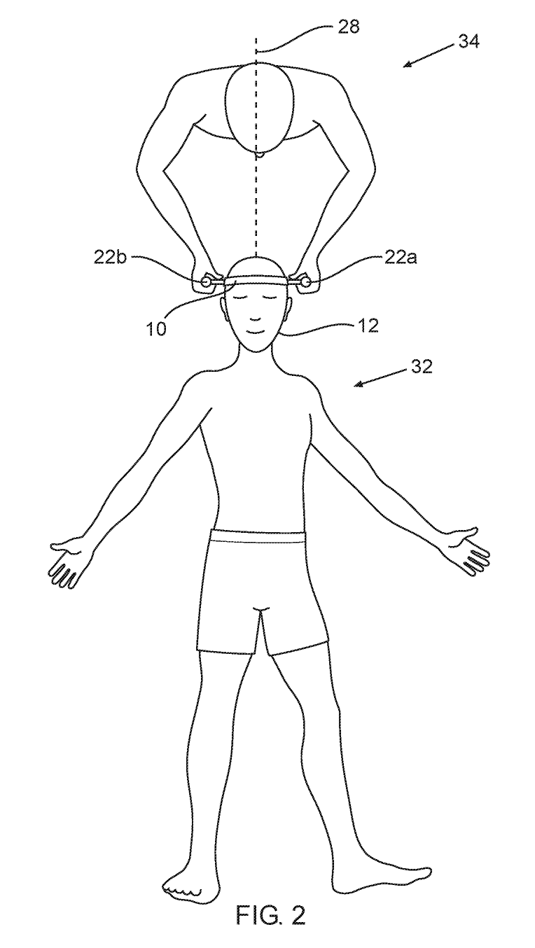

In FIG. 2, a subject 32 is depicted floating face-up in the water, wearing headgear 10 according to an embodiment of the teachings herein. A treating person 34 is standing in the water at head 12 of subject 32 along vertical axis 28 of headgear 10, with two hands holding handles 22, allowing implementation of an embodiment of the teachings herein.

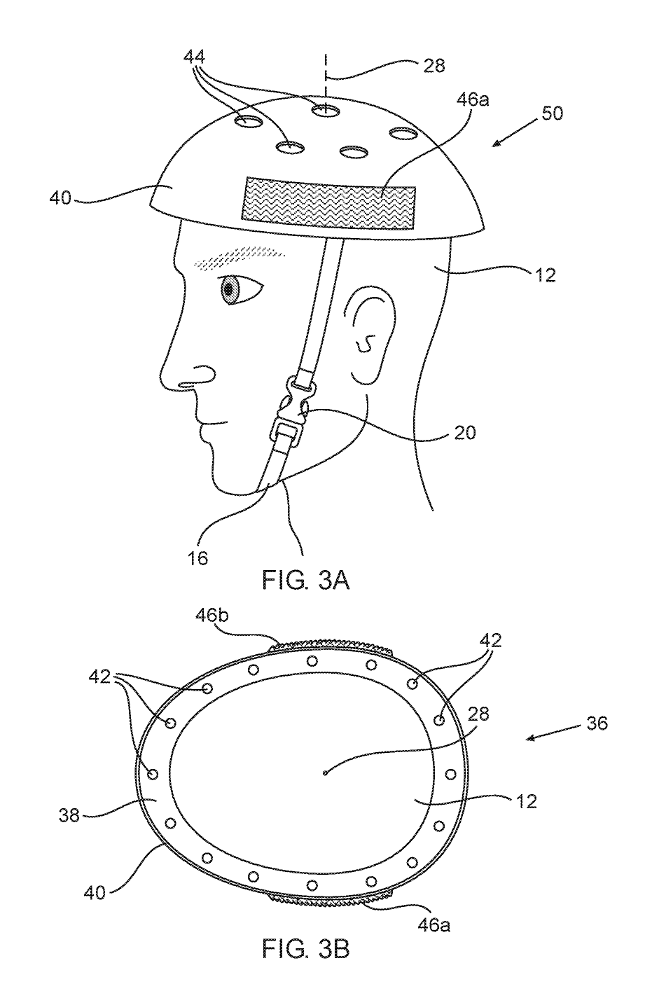

An embodiment of headgear 36 according to the teachings herein is schematically depicted in FIGS. 3 in side view (FIG. 3A) and cross section from the top (FIG. 3B) worn on the head 12 of a subject. Headgear 36 comprises as a head encircler, an extruded polystyrene foam (styrofoam®) 4 cm thick ring 38 encircling head 12, a chin strap 16 functionally associated with ring 38 encircling head 12 underneath the chin, chin strap 16 made of UHMWPE webbing (3 mm thick). Chin strap 16 is a discontinuous band that can be opened and closed, using a quick-release plastic buckle 20 with integrated strap-adjuster slide functionality, allowing adjustment of the diameter of chin strap 16. For use with a specific person, a headgear 36 having a correctly sized foam ring 38 is selected, and the diameter of chin strap 16 is properly adjusted, so that headgear 10 is immovably secured to head 12.

Covering foam ring 38 so as to surround the upper part of the skull of a human wearing headgear 36 is a 1 mm thick hard polycarbonate shell 40. Foam ring 38 and shell 40 are fused during manufacture by molding-in-the-shell of foam ring 38. To avoid water absorption into foam ring 38, all exposed surfaces of foam ring 38 are covered with a water-impermeable coating (silicone sealant) thereby rendering headgear 36 water proof. To increase the density of headgear 36, and thereby reduce the buoyancy caused by the low density of foam ring 38 (45 g/l), rods 42 of aluminum are embedded inside foam ring 38 as weighting components. The distribution of rods 42 is evenly around foam ring 38 so that no torque is produced on the head of a wearer by the weight of rods 42. The total weight of rods 42 is such that the density of headgear 36 is 1.0 g/ml.

The top of shell 40 includes 1 cm diameter perforations 44 that allow water flow into and out of the volume defined above the head of the wearer, surrounded by foam ring 38 and beneath the inner surface of shell 40.

The thickness of the back 30 of headgear 36 is defined by the sum of the thicknesses of foam ring 38 (4 cm) and of shell 40 (1 mm)

Shell 40 is shaped like a cap covering the crown of the head of a wearer, thereby leaving the cervical spine of a wearer accessible and free of obstruction.

Most of the outer surface of shell 40 of headgear is smooth polycarbonate. On either side of shell 40 is a a slip-resistant area 46a (on the left side) and 46b (on the right side) fashioned of a textured black rubber panels having a rough textured surface (including protrusions). Even when areas 46 are wet, the wet hands of a person have sufficient grip on slip resistant areas 46 allowing non-sliding contact with a naked human hand when wet. Slip resistant areas 46 allow a treating person standing in the water at the head of the subject near the vertical axis 28 of headgear 36 to easily move a head 12 by contacting slip-resistant areas 46 with the hands in accordance with the teachings herein.

Some embodiments of headgear according to the teachings herein resemble headgear 36, but are devoid of weighting components such as rods 42. In such embodiments, the headgear applies an upwards force to the head of a wearer when immersed due to positive buoyancy.

Some embodiments of headgear according to the teachings herein resemble headgear 36, but instead of two separate slip-resistant areas 46, includes a single continuous slip resistant area found on both sides of the headgear.

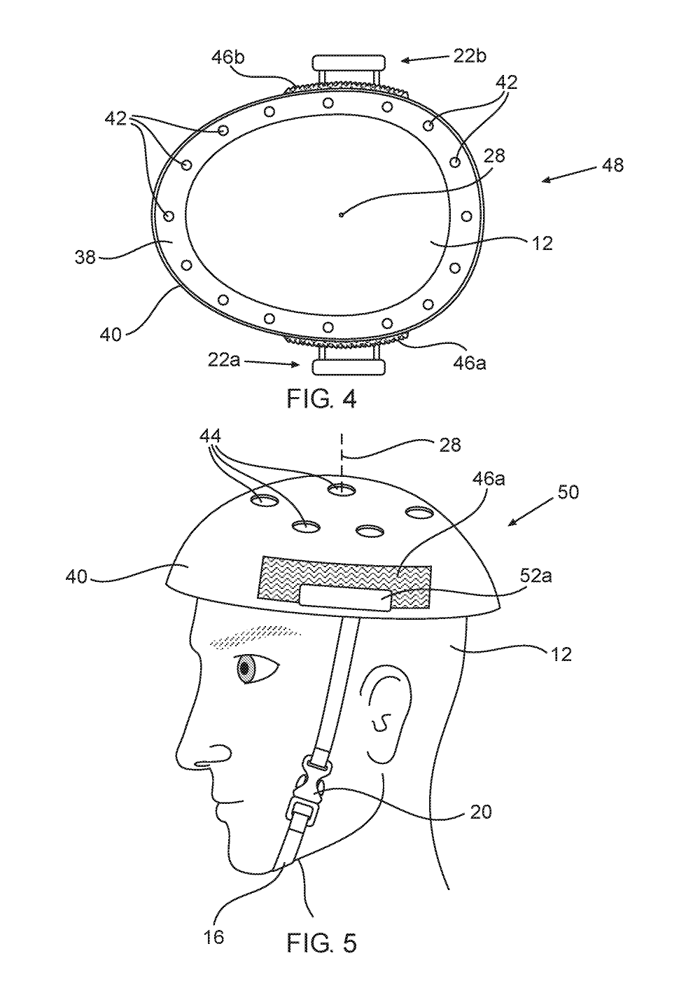

Some embodiments of headgear according to the teachings herein resemble headgear 36, but instead of or in addition to slip-resistant areas 46, include elongated protrusions as described above, such as handles 22 of headgear 10, see headgear 48 in FIG. 4. Handles 22 are not detachable from headgear 48.

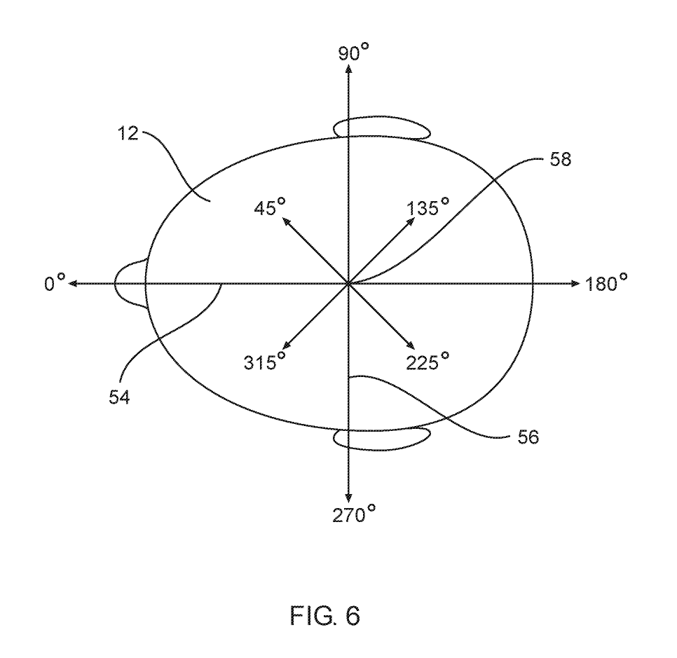

Some embodiments of headgear according to the teachings herein, for example headgear 50 depicted in FIG. 5, resemble headgear 36, but instead of or in addition to slip-resistant areas 46, include elongated slits 52 in shell 40, having a width allowing insertion of fingers therein.

### Maintenance and Physical Improvement

Subsequent to diagnosis and pain reduction (as discussed above), a hydrotherapist (optionally together with an additional health-care professional) may decide that the person being treated should enter a period of maintenance (of the reduced pain, the achieved mobility and range of motion, arresting further degeneration) and, if possible, improvement of the person's health state and quality of life, including, improved physical condition, mobility and/or strength. Such a period may include the person performing various types of physical exercise (in and/or out of the water, typically under the supervision of a physiotherapist or hydrotherapist) as well as physiotherapeutic and/or hydrotherapeutic treatment by a physiotherapist or hydrotherapist.

Such exercise and treatment often becomes a permanent part of the person's lifestyle requiring one or two sessions a week, while stopping such exercise and treatment may lead to the return of the pain, limitation of motion and degeneration. It is known that in many cases using physiotherapeutic methods known in the art, subsequent substantial improvement of the person's health is often difficult or impossible to achieve, and in some instances, even maintenance of the achieved state is challenging.

The Inventor has found and herein discloses that improved results can often be achieved when the person undergoes hydrotherapeutic treatment or performs hydrotherapeutic exercises while the head supports an asymmetrically-loaded attached weight, where the weight is loaded at one of the four quadrant positions (front, back, left side or right side) of the head. Although not wishing to be held to any one theory, it is currently believed that the improved results are attributable to the asymmetric loading that leads to increased neck muscle strength while the body is supported by buoyancy in the water, and in some embodiments, when there is reduced stress on the neck and spine due to buoyancy in the water. It has been found that, in some cases, the methods disclosed herein allow a longer time between exercise/treatment sessions, improving the quality of life of the treated person. As discussed in detail below, it is also believed that the use of an asymmetrically-loaded weight makes the exercise more efficient and prevents repetitive stress injury to already injured parts of a subject's body.

Thus, according to an aspect of some embodiments of the teachings herein, there is also provided a method of performing hydrotherapy on a human subject in need thereof, comprising:
a. immersing at least part of the body of a human subject in water; and
b. while the at least part of the body is immersed in the water, moving the head of the subject while an artificial free weight is affixed to the head in a fixed asymmetric distribution.

In some embodiments, the need of the subject arises from pain, in some embodiments, in the cervical spine. In some embodiments, the need of the subject arises from a musculoskeletal disorder, in some embodiments, of the cervical spine. In some embodiments, the musculoskeletal disorder is selected from the group consisting of: cervical disk lesion, cervical disk protrusion, cervical pain, cervical spine fracture, disk herniation, inflammation of neck muscles and/or tendons, limitation of range of motion of the neck, musculoskeletal degeneration, spinal stenosis, spondylosis, torticollus, weakness in neck muscles (e.g., sternocleidomastoid) and whiplash. In some embodiments, the need of the subject arises from the need for post-operative recovery.

Typically, the moving of the head of the subject while the artificial weight is affixed to the head is performed by the subject self during a treatment session, preferably under supervision and observation of another person who is not the subject, usually a health-care professional, such as a physical therapist, especially a hydrotherapist.

During such supervision, the other person decides the amount of the artificial weight, the asymmetric distribution, the type of movement, and the number of repetitions, and instructs the subject what to do accordingly. Such decision is based, inter alia, on professional judgment, knowledge of the condition of the subject as well as observation of how the subject is faring during the session.

In some embodiments, another person who is not the subject helps move the head of the subject by holding the head (directly or indirectly through some headgear) with the hands, and then helping the subject move the head. Typically, the person is a health-care professional such as a physical therapist, especially a hydrotherapist.

In some embodiments, in the initial phase of treatment (typically 2-3 months), the moving of the subject according to the teachings herein is under direct and intense supervision of another person such as a health-care professional.

In some embodiments, in a later phase of treatment, the moving of the subject according to the teachings herein with weights secured to a headgear is done by the subject self (e.g., independent swimming where the person lays in the water face-down or face-up) with occasional consultation with another person such as a health-care professional. Typically, swimming is required with at least 3 sessions a week, each session of at least 30 minutes duration. In some such embodiments, the subject is directed to swim without removing the limbs from the water to prevent an undesirable increase of weight or pressure on the vertebrae, although if the swimming is face down the subject is advised to remove face and hair from the water in order to breathe, With sufficient improvement in later phases, the subject is optionally directed to swim with weights symmetrically distributed on the head gear and even to remove the limbs from the water. The weight that is added is typically as much as the subject can bear. In addition to the advantages gained by implementing the method of the teachings herein, the subject gains an increase of physical fitness from swimming with an added weight. With sufficient improvement, at a later phase the subject may distribute weights on the headgear symmetrically

As noted above, immersion in water provides buoyancy that reduces stress on the muscles joints and ligaments of a subject, provides temperature control of the subjects body, (especially peripheral portions and portions with relatively less blood flow) and provides physical that provides a level of analgesia. It has been found and is here reported that moving the head while an artificial weight is affixed to the head in a fixed asymmetric distribution while at least some of the subject is immersed in water provides exceptional benefit to the subject, especially therapeutic benefit.

As noted above, the moving the head is performed while at least part of the body is immersed in the water.

In some embodiments, during the moving of the head, the subject is laying face-up in the water.

In some embodiments, during the immersion, the subject is laying on the side in the water.

In some embodiments, during the moving of the head, the subject is laying face-down in the water. In some such embodiments, a treating person ensures that the subject can breathe by intermittent rotation and/or sagittal flexion of the head, sufficient to allow breathing.

In some embodiments, during the moving of the head, the subject is floating in the water face-up, that is to say, the subject is at least partially immersed floating face-up in water with nose and mouth outside of the water. In some such embodiments, the subject is functionally associated with a flotation aid (e.g., flotation vest, flotation noodle). In some embodiments, the method comprises, prior to the moving of the head, functionally associating the subject with a flotation aid.

That said, in some instances, a person being treated is not allowed to completely lay down for a medical reason, for example, having high blood pressure. Accordingly, in some embodiments, during the moving of the head the subject is at least partially immersed, in some embodiments laying face-up (e.g., on an at least partially submerged object such as a couch or similar) in water with nose and mouth outside of the water. In some embodiments the subject is at least partially immersed sitting in water (e.g., on an at least partially object such as a chair or similar) with nose and mouth outside of the water.

In some embodiments, the part of the body that is immersed is from the feet up to the hips. In some embodiments, the part of the body that is immersed is from the feet up to the abdomen (just below the breasts). In some embodiments, the part of the body that is immersed is from the feet up to the and including the torso (up to and including the shoulders). In some embodiments, the part of the body that is immersed is from the feet up to the and including the neck (up to just below the chin). In some embodiments, the part of the body that is immersed includes the back of the head. In some embodiments, the part of the body that is immersed intermittently includes the face.

In some embodiments, while the subject is immersed in the water, the method further comprises supporting the subject to ensure that the nose and mouth do not submerge in the water. In some such embodiments, support is afforded by a person different that the subject (e.g., a health-care professional) supporting the subject from below. In some such embodiments, support is afforded by a flotation aid.

In some embodiments, the method further comprises prior to moving the head (‘b’), securing the artificial weight to the head of the subject in a first fixed asymmetric distribution to the head.

In some embodiments, the artificial weight that is affixed to the head is borne on a headgear worn by the subject. In some such embodiments, the method further comprises prior to moving the head (‘b’), securing the headgear bearing the artificial weight to the head of the subject.

The moving of the head of the subject to effect the hydrotherapy is any suitable movement. In some embodiments, the moving is at least one of:
i. rotating the head of the subject (as noted above, rotation of the head around the cervical axis in the transverse plane);
ii. sagittal flexion of the neck of the subject (as noted above, tilting the head by bending the neck back and forth in the sagittal plane);
iii. side flexion of the neck of the subject (tilting the head by bending the neck left and right in the frontal plane);
iv. if the moving of the head is performed by a person who is not the subject, pulling the head of the subject in the vertical axis. In some embodiments, the pulling of the head in the vertical axis drags the subject through the water; and leading to extension of the neck.
v. combinations (in some embodiments, simultaneous combinations) of i, ii, iii and iv, for example side flexion and rotation, simultaneously or serially.

In some embodiments, rotation includes 360° of the head of the subject, that leads to 360° rotation of the entire body of the subject.

A typical treatment session is between 15 and 60 minutes, more typically not less than 20 minutes and even not less than 25 minutes, not more than 45 minutes, and even not more than 40 minutes. The actual length of a given session is typically determined by a health-care professional.

The frequency of treatment sessions is any suitable frequency, typically as determined by a health-care professional such as a hydrotherapist. The Inventor currently believes that the minimal frequency is once a week, but can increase to daily treatment sessions when the subject suffers from pain.

A typical session includes one or more sets of one or more different movements of the head, e.g., at least one of rotating of the head, sagittal flexion of the neck, side flexion of the neck, pulling of the head, and combinations thereof. In some embodiments, between two sets, the subject rests. In some embodiments, between two sets, the head is pulled by a person who is not the subject, e.g., through the water. in some embodiments thereby reducing muscle tone and increasing fluid flow to the cervical spine. The actual number of sets, what movement is done in the set, and what is done between any two sets is typically determined by a health-care professional.

Typically, during a set, the head of the subject is moved with a given asymmetric distribution of weight in at least one of rotating of the head, sagittal flexion of the neck, side flexion of the neck, pulling of the head and combinations thereof in a number of repetitions (typically between 3 and 20 repetitions, typically not more than 10 repetitions and even not more than 5 repetitions). In some preferred embodiments, each repetition is performed slowly, over a duration of between 5 and 15 seconds, typically 10 seconds (with continuous motion, intermittent motion, or pause at the two extremes).

Typically, during a single treatment session the head is moved in a set with a given asymmetric weight distribution, the asymmetric distribution is changed to a different asymmetric distribution, and the head is moved again in a set with the different asymmetric distribution. Accordingly, in some embodiments, the method further comprises: during the moving the head, changing the fixed asymmetric distribution from a preceding fixed asymmetric distribution to a different succeeding fixed asymmetric distribution.

As noted above, the head of the subject is moved while an artificial weight is affixed to the head in a fixed asymmetric distribution.

The artificial weight is affixed to the head in any suitable manner In some embodiments, the asymmetric distribution is such that, when the subject stands with the weight in the asymmetric distribution, skeletal muscles of the neck are contracted in order to keep the head upright.

To have a substantial effect, for example, substantial therapeutic effect, in some embodiments it is preferred that the artificial weight is fixed so that, when the subject stands with the weight in the asymmetric distribution, the weight applies a downwards tilting force to the head, as opposed to a force rotating the head in the cervical axis, or a force tilting the head by pulling in a direction perpendicular to the cervical axis. Accordingly, in some embodiments, the center of mass of the artificial weight is not less than 3 cm, not less than 4 cm, and in some embodiments not less than 5 cm from the surface of the head of the subject. Typically, the center of mass of the artificial weight is not more than 50 cm from the surface of the head of the subject.

The amount of the weight that is asymmetrically distributed is any suitable amount. Typically, the amount of weight is determined by a health-care professional, such as a physiotherapist, especially a hydrotherapist. Over time, the amount of weight is optionally increased or decreased as required, typically as a decision made by the health-care professional. In some embodiments, the artificial weight is not less than about 50 gram. In some embodiments, the artificial weight is not less than about 100 gram. That said, in some embodiments, the artificial weight is not more than 1500 gram. The density of the artificial weight is any suitable density. That said, in some embodiments it is preferred that the weight have a density of not less than 3 g/ml, not less than 4 g/ml and even not less than 5 g/ml.

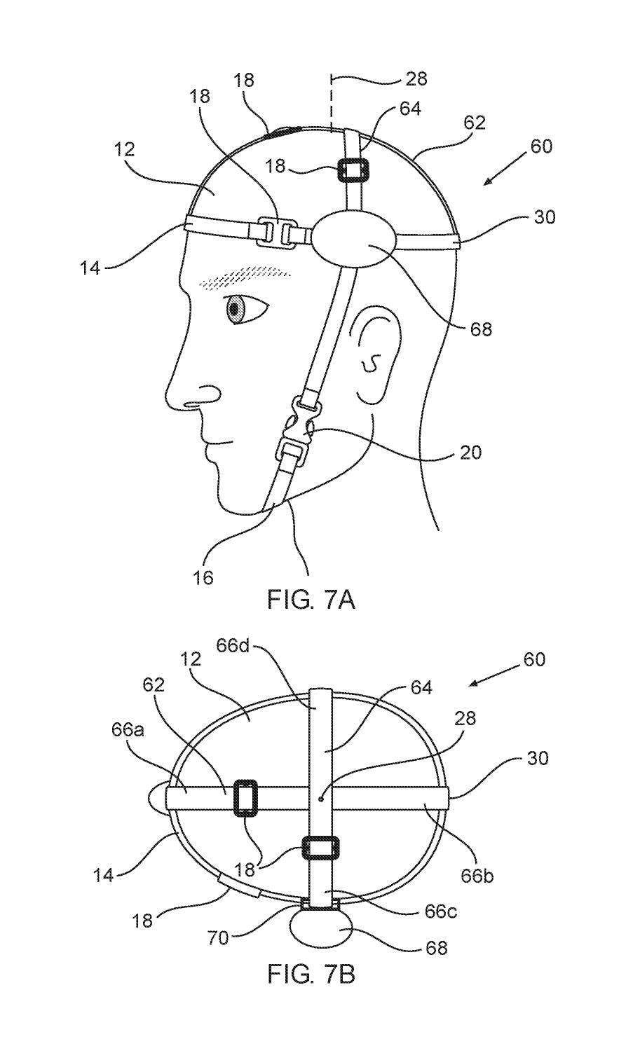

The asymmetric distribution of the weight is any suitable asymmetric distribution. In FIG. 6, a head 12 of a subject is depicted in top view, with the sagittal axis 54, the transverse axis 56 and the vertical axis 58 marked. A transverse plane is a plane that includes sagittal axis 54 and transverse axis 56 and is perpendicular to vertical axis 58. Indicated with reference to the sagittal and transverse axes are the 0°, 45°, 90°, 135°, 180°, 225°, 270° and 315° directions of the transverse plane.

In some embodiments, the asymmetric distribution is such that the center of mass of the artificial weight is located towards the front of the head in a direction within 30° of the 0° direction of the transverse plane (to an observer viewing the head from above along the cervical axis), see FIG. 6. In some such embodiments, the direction is within 20°, within 10° and even within 5° of the 0° direction of the transverse plane.

In some embodiments, the asymmetric distribution is such that the center of mass of the artificial weight is located towards the right of the head in a direction within 30° of the 90° direction of the transverse plane (to an observer viewing the head from above along the cervical axis), see FIG. 4. In some such embodiments, the direction is within 20°, within 10° and even within 5° of the 0° direction of the transverse plane.

In some embodiments, the asymmetric distribution is such that the center of mass of the artificial weight is located towards the back of the head in a d direction within 30° of the 180° direction of the transverse plane (to an observer viewing the head from above along the cervical axis), see FIG. 4. In some such embodiments, the direction is within 20°, within 10° and even within 5° of the 0° direction of the transverse plane.

In some embodiments, the asymmetric distribution is such that the center of mass of the artificial weight is located towards the left side of the head in a direction within 30° of the 270° direction of the transverse plane (to an observer viewing the head from above along the cervical axis), see FIG. 4. In some such embodiments, the direction is within 20°, within 10° and even within 5° of the 0° direction of the transverse plane.

In some embodiments where the subject has a condition that is expressed in difficulties in nodding the head (sagittal flexion), the asymmetric distribution is such that the center of mass of the artificial weight is located towards the front, the back or both the front and the back of the head during a treatment session. Preferably, in a single session the subject moves the head when the artificial weight is located towards the front of the head, and also moves the head when the artificial weight is located towards the back of the head.

In some embodiments where the subject has a condition that is expressed in difficulties in shaking (rotating) or bobbling the head (side flexion), the asymmetric distribution is such that the center of mass of the artificial weight is located towards the left side, the right side or both sides of the head during a treatment session. Preferably, in a single session the subject moves the head when the artificial weight is located towards the left side of the head, and also moves the head when the artificial weight is located towards the right side of the head.

For example, a subject having some pathology related to one or both sides of the sternocleidomastoid muscles (e.g., inflammation of the muscle or related tendons) will have pain and/or difficulty when trying to nod the head forwards (sagittal flexion) and shaking the head in one or both directions (rotation). In some embodiments of the method of the teachings herein, the subject will be asked to do repetitions of four separate exercises that involve moving the head in accordance with the teachings herein during a single session:

sagittal flexion of the neck while the asymmetric distribution is such that the center of mass of the artificial weight is located towards the front of the head;

sagittal flexion of the neck while the asymmetric distribution is such that the center of mass of the artificial weight is located towards the back of the head;

side flexion of the neck while the asymmetric distribution is such that the center of mass of the artificial weight is located towards the left side of the head; and

side flexion of the neck while the asymmetric distribution is such that the center of mass of the artificial weight is located towards the right side of the head.

As noted above, the duration of order of the head movements, the number of sets and the number of repetitions in each set is typically decided by a health-care professional.

When the asymmetric distribution is such that the center of mass of the artificial weight is located towards the front or the back of the head, any suitable movement of the head may be performed, including rotation, sagittal flexion of the neck and side flexion of the neck. That said, in some embodiments when the asymmetric distribution is such that the center of mass of the artificial weight is located towards the front or the back of the head , the preferred movement of the head is sagittal flexion of the neck, effectively lifting the head out of the water by forward sagittal flexion, and returning the head to the water by back sagittal flexion.

When the asymmetric distribution is such that the center of mass of the artificial weight is located towards the left side or the right side of the head, any suitable movement of the head may be performed, including rotation, sagittal flexion of the neck and side flexion of the neck. That said, in some embodiments when the asymmetric distribution is such that the center of mass of the artificial weight is located towards the left side or the right side of the head, the preferred movement of the head is rotating of the head, effectively rotating the head in one direction to lift the weight further from the water, and then rotating the head in the opposite direction to lower the weight closer to the water or into the water.

Embodiments of the method described above may be implemented using any suitable artificial weight affixed to the head of the subject in any suitable manner As noted above, in some embodiments, the artificial weight that is affixed to the head is borne on a headgear worn by the subject. Such embodiments may be implemented using any suitable headgear. That said, in some embodiments it is preferred to use a headgear according to the teachings herein.

### Headgear Suitable for Use in Maintenance and Physical Improvement

According to an aspect of some embodiments of the teaching herein, there is provided headgear suitable for use in hydrotherapy, comprising:
a head encircler configured to encircle the head of a human around the skull;
a chin strap functionally associated with the head encircler, configured to encircle the head of a human underneath the chin,
   the head encircler and chin strap together configured to immovably secure the headgear to the head of a human wearer, and
   the headgear configured for substantially immovable support of an attached free weight of at least 100 g through at least one attachment locus at at least four quadrant positions of the transverse plane of the headgear one at a time:
i. a front position where the center of mass of the attached weight is located towards the front of the headgear in a direction within 30° of the 0° direction of the transverse plane, and in some embodiments, not more than 20°, not more than 10° and even not more than 5° of the 0° direction of the transverse plane;
ii. a right position where the center of mass of the attached weight is located towards the right of the headgear in a direction within 30° of the 90° direction of the transverse plane, and in some embodiments, not more than 20°, not more than 10° and even not more than 5° of the 90° direction of the transverse plane;
iii. a back position where the center of mass of the attached weight is located towards the back of the headgear in a direction within 30° of the 180° direction of the transverse plane, and in some embodiments, not more than 20°, not more than 10° and even not more than 5° of the 180° direction of the transverse plane; and
iv. a left position where the center of mass of the attached weight is located towards the left of the headgear in a direction within 30° of the 270° direction of the transverse plane, and in some embodiments, not more than 20°, not more than 10° and even not more than 5° of the 270° direction of the transverse plane.

Preferably, the headgear is waterproof, that is to say, is fashioned in a manner and of materials that are not damaged by prolonged contact with water; do not absorb water and do not change shape or dimensions when immersed in water.

In some embodiments, the headgear, excluding an attached weight, has a density of between 0.97 and 1.03 g/ml. That said, in some embodiments, the headgear, excluding an attached weight, is configured to float on fresh water.

In some embodiments, a head encircler has a fixed diameter, e.g., a foamed-plastic headgear crown portion or a fixed diameter headband. In some embodiments, a head encircler is flexible, e.g.., a flexible headband. In some embodiments, a head encircler has an adjustable diameter to fit on different sized/shaped human heads, e.g., is an adjustable headband. In some embodiments, a head encircler is elastically stretchable, allowing stretching and contracting to fit around a head of a wearer. That said, in some embodiments, a head encircler is not stretchable. In some embodiments, a head encircler is a continuous headband. In some embodiments, the head encircler is a discontinuous headband configured to be opened and closed (e.g., with a hook and loop fastener or a buckle).

In some embodiments, a chinstrap has an adjustable diameter to fit on different sized/shaped human heads. In some embodiments, a chinstrap is elastically stretchable, allowing stretching and contracting to fit around a chin of a wearer. In some embodiments, a chinstrap is not-stretchable. In some embodiments, a chinstrap is a continuous band. In some embodiments, a chinstrap is a discontinuous band configured to be opened and closed (e.g., with a hook and loop fastener or a buckle).

In some embodiments, the headgear is configured to leave the cervical spine (c1-c7) of a wearer free of obstruction, sufficient to allow a health-care professional (such as a hydrotherapist) access to the cervical spine.

If when worn the headgear protrudes relatively far from the back of the head, the protrusion potentially interferes with manipulation of the head of a wearer by a health-care professional. Accordingly, in some embodiments, the back of the headgear, excluding an attached weight, protrudes by not more than 5 cm, not more than 4 cm and even not more than 3 cm from the inner surface of the headband (and therefore from the back of the head of a wearer).

In some embodiments, the headgear consists essentially of webbing and is devoid of a shell. In some embodiments, the headgear comprises a shell configured to at least partially surround the skull of a human wearing the headgear functionally associated with the head encircler, preferably a non-water absorbent hard shell as described with reference to FIGS. 3. In some embodiments, such a shell provides the headgear with durability and structural strength for attachment of the weights. In some embodiments, such a shell provides safety, preventing a wearers head from injury, for example from a falling weight.

Position of the weights in the transverse plane In some embodiments, the headgear is configured for substantially immovable support of an attached weight of at least 100 g, at the at least four quadrant positions of the transverse plane of the headgear one at a time:
i. a front position where the center of mass of the attached weight is located towards the front of the headgear in a direction that is not more than 30° from the 0° direction of the transverse plane, and in some embodiments, not more than 20°, not more than 10° and even not more than 5° from the 0° direction of the transverse plane;
ii. a right position where the center of mass of the attached weight is located towards the right of the headgear in a direction that is not more than 30° from the 90° direction of the transverse plane, and in some embodiments, not more than 20°, not more than 10° and even not more than 5° from the 90° direction of the transverse plane;
iii. a back position where the center of mass of the attached weight is located towards the back of the headgear in a direction that is not more than 30° from the 180° direction of the transverse plane, and in some embodiments, not more than 20°, not more than 10° and even not more than 5° from the 180° direction of the transverse plane;
iv. a left position where the center of mass of the attached weight is located towards the left of the headgear in a direction that is not more than 30° from the 270° direction of the transverse plane, and in some embodiments, not more than 20°, not more than 10° and even not more than 5° from the 270° direction of the transverse plane.

In some embodiments, the headgear is configured for substantially immovable support of an attached weight of at least 100 g at at least four positions of the transverse plane of the headgear one at a time different from the four quadrant positions:
i. a front-right position where the center of mass of the attached weight is located towards the front-right of the headgear in a direction that is not more than 20° from the 45° direction of the transverse plane, and in some embodiments, not more than 10° and even not more than 5° from the 45° direction of the transverse plane;
ii. a back-right position where the center of mass of the attached weight is located towards the back-right of the headgear in a direction that is not more than 20° from the 135° direction of the transverse plane, and in some embodiments, not more than 10° and even not more than 5° from the 135° direction of the transverse plane;
iii. a back-left position where the center of mass of the attached weight is located towards the back of the headgear in a direction that is not more than 20° from the 225° direction of the transverse plane, and in some embodiments, not more than 10° and even not more than 5° from the 225° direction of the transverse plane;
iv. a front-left position where the center of mass of the attached weight is located towards the front-left of the headgear in a direction that is not more than 20° from the 315° direction of the transverse plane, and in some embodiments, not more than 10° and even not more than 5° from the 315° direction of the transverse plane.

### Elevation of the Weights

The elevation of a free weight attached as described above to the headgear is any suitable elevation. In some embodiments, the elevation is fixed. In some embodiments, the elevation is changeable.

### Attachment Loci

As noted above, a headgear according to the teachings herein includes at least one attachment locus to which free weights can be attached to the headgear to be substantially immovably supported at at least the four quadrant positions. Attachment loci is a term referring to many different types of components and configurations including, rails, holes, clips and slots that allow attachment of an appropriately configured free weight.

In some embodiments, the headgear comprises a movable attachment locus. In some embodiments, the movable attachment locus has at least two states:

a locked state, wherein the movable attachment locus is substantially immovably located at one of the four quadrant positions of the headgear, and

an adjusting state, wherein the movable attachment locus is movable from one of the four quadrant positions to another of the four quadrant positions.

In some embodiments, the movable attachment locus has at least four locked states, in each of the four locked states being substantially immovably located at a different one of the four quadrant positions of the headgear. In some such embodiments, the movable attachment locus has more than four locked states, in each such locked state being substantially immovably located at a different positions of the transverse plane of the headgear.

In some embodiments, the movable attachment locus is configured to have at least two different locked states located at the same positions of the transverse plane of the headgear, but having a different elevation.

In some embodiments, the headgear comprises a component weight weighing at least 50 g and in some embodiments weighing at least 100 g, the component weight substantially inseparably attached to the movable attachment locus.

In some embodiments, the headgear comprises a plurality of attachment loci, the plurality of attachment loci allowing attachment of a free weight at least at the four quadrant positions of the transverse plane of the headgear. In some embodiments, the plurality of attachment loci allow attachment of a free weight at additional positions of the transverse plane different from the four quadrant positions.

Weights and a Kit

As noted above, the headsgear is configured for substantially immovable support of an attached free weight of at least 100 g, at at least the four quadrant positions of the transverse plane of the headgear one at a time through one or more attachment loci. In some embodiments, the headgear is configured for substantially immovable support of an attached free weight greater than 100 g, at at least the four quadrant positions of the transverse plane of the headgear one at a time, in some embodiments, not less than 300 g, not less than 400 g, not less than 600 g, not less than 800 g and even not less than 1000 g.

Any suitable free weights may be attached to the headgear, depending on the configuration of the headgear and of the attachment loci. In preferred embodiments, weights attached to the headgear for implementing the teachings herein are waterproof.

The density of the free weights is any suitable density. That said, in some embodiments it is preferred that the free weights have a density of not less than 3 g/ml, not less than 4 g/ml and even not less than 5 g/ml. Typically, the material from which the free weights are fashioned comprises a metal or ceramic, for example iron, lead, zirconia, and cermet.

In some embodiments, the attachment loci are configured to support known available weights, for example, commercially-available barbell or bean bag weights.

In some embodiments, the attachment loci are configured to support weights specially configured to mate with the attachment loci.

In some embodiments, the headgear further comprises at least one free weight, attachable to the headgear through an attachment locus. In some embodiments, the at least one free weight comprises a number of free weights selected from the group consisting of at least 2, at least 4, at least 6 and at least 8 free weights attachable to the headgear through an attachment locus. In some embodiments, the attachment loci and the weights are configured to allow incremental adjustment of the total weight attached to the headgear at a quadrant position. In some embodiments, the increment of the incremental adjustment is by increments of not less than 10 g and not more than 250 g.

In some embodiments, the free weights and the attachment loci are configured for attachment of a single free weight to an attachment locus at any one time. In some such embodiments, some or all of the free weights have a different weight, allowing incremental adjustment of the weight attached to the headgear during implementation of the teachings herein. For example, in some embodiments, the headgear comprises 8 free weights: 50 g, 100 g, 150 g, 200 g, 250 g, 300 g, 350 g and 400 g, allowing loading of the headgear at any one of the quadrant locations from 50 g to 400 g at 50 g intervals.

In some embodiments, the weights and the attachment loci are configured for attachment of multiple weights to an attachment locus at any one time, allowing incremental adjustment of the weight attached to the headgear during implementation of the teachings herein. For example, in some embodiments, the headgear comprises 6 free weights: 12.5, 25 g, 50 g, 100 g, 200 g, 400 g. The attachment loci and weights are configured to attach anything from one to all six of the free weights at any one time to a given attachment locus, allowing loading of the headgear at any one of the quadrant locations from 12.5 g to 787.5 gin increments of 12.5 g.

In some embodiments, the headgear and attachable weights are provided as a kit. Accordingly, according to an aspect of some embodiments of the teachings herein, there is also provided a kit suitable for use in hydrotherapy, comprising:
a headgear as described above; and
at least one free weight, attachable to the headgear through the at least one attachment locus.

In some embodiments, the at least one free weight comprises a number of free weights selected from the group consisting of at least 2, at least 4, at least 6 and at least 8 free weights attachable to the headgear through an attachment locus.

In some embodiments, the attachment loci and the weights are configured to allow incremental adjustment of the total weight attached to the headgear at a quadrant position. In some embodiments, the increment of the incremental adjustment is by increments of not less than 10 g and not more than 250 g.

In some embodiments, the weights and the attachment loci of the kit are configured for attachment of a single weight to an attachment locus at any one time. In some such embodiments, some or all of the free weights have a different weight, allowing incremental adjustment of the weight attached to the headgear during implementation of the teachings herein. For example, in some embodiments, the kit comprises 8 free weights: 50 g, 100 g, 150 g, 200 g, 250 g, 300 g, 350 g and 400 g, allowing loading of the headgear at any one of the quadrant locations from 50 g to 400 g at 50 g intervals.

In some embodiments, the weights and the attachment loci of the kit are configured for attachment of multiple weights to an attachment locus at any one time, allowing incremental adjustment of the weight attached to the headgear during implementation of the teachings herein.

For example, in some embodiments, the kit comprises 6 free weights: 12.5, 25 g, 50 g, 100 g, 200 g, 400 g. The attachment loci and weights are configured to attach anything from one to all six of the free weights at any one time to a given attachment locus, allowing loading of the headgear at any one of the quadrant locations from 12.5 g to 787.5 g in increments of 12.5 g.

In some embodiments of the headgear or the kit, one of: the at least one attachment locus; the at least one free weights; and both the at least one attachment locus and the at least one free weights are configured so that the center of mass of the free weight when attached to the attachment locus is maintained at an offset distance from the surface of the head of a person wearing the headgear. In some embodiments, the offset distance is not less than 3 cm, not less than 4 cm and in some embodiments not less than 5 cm. Typically, the offset distance is not more than 50 cm.

In some embodiments of the headgear or the kit, one of: the at least one attachment locus; the at least one free weights; and both the at least one attachment locus and the at least one free weights are configured so that the center of mass of the free weight when attached to the attachment locus is at a distance from the vertical axis of the head of a wearer that is not greater than the distance from the vertical axis of the ears of a wearer. In some embodiments, the center of mass of an attached free weight is at a distance from the vertical axis of the head of a wearer that is greater than the distance from the vertical axis of the ears of a wearer, in some embodiments, not less than 1 cm greater, and in some embodiments not less than 2 cm greater.

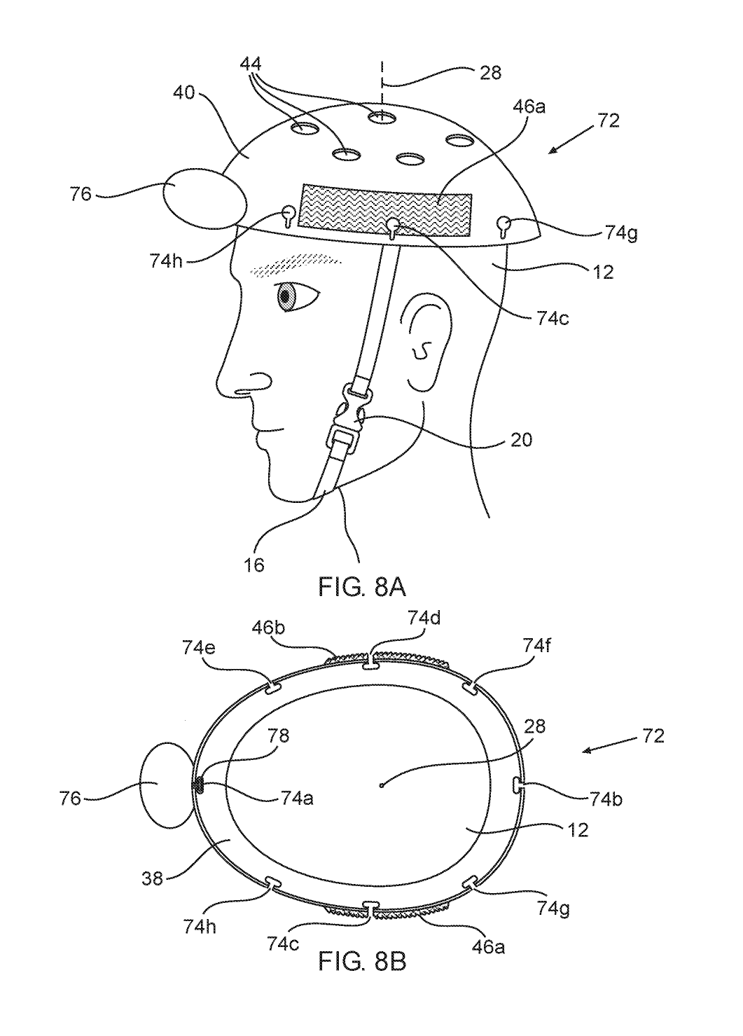

An embodiment of headgear according to the teachings herein, headgear 60, is schematically depicted in FIGS. 7 in side view (FIG. 7A) and top view (FIG. 7B) worn on the head 12 of a subject. Headgear 60 consists essentially of webbing and is devoid of a shell. Specifically, headgear 60 comprises, as a head encircler, an adjustable headband 14 and an adjustable chin strap 16 substantially as described with reference to headgear 10 in FIGS. 1. When secured to the head with the diameters of headband 14 and chin strap 16 properly adjusted, headgear 10 is immovably secured to head 12.

Extending from the front to the back of headband 12 and covering the crown of a head 12 is a sagittal weight-supporting strap 62. Extending from the left side to the right side of headband 12 and covering the crown of a head 12 is a transverse weight-supporting strap 64. Both straps 62 and 64 are 5 cm and made of the same material as headband 14 and chin strap 16, and are adjustable in length using a strap adjuster slide 18. The two intersections of sagittal weight-supporting strap 62 with headband 12 (66a, 66b) and the two intersection of transverse weight-supporting strap 64 with headband 12 (66c, 66d) constitute the four attachment loci of headgear 60.

Headgear 60 comprises a specially-configured free weight 68. Headgear 60 and free weight 68 and together are considered a headgear and weight kit according to the teachings herein. Weight 68 is an ovoid-shaped piece of lead covered with rubber weighing a total of 400 g. Weight 68 includes a metal clip 70 configured to engage either sagittal weight supporting strap 62 or transverse weight supporting strap 64 at one of attachment loci 66 in order to attach weight 68 to headgear 60. When clip 70 engages a supporting strap 62 or 64 at an attachment locus 66, weight 68 is substantially immovably supported on headgear 60 at one of the four quadrant positions of the transverse plane of headgear 60: at 66a in the 0° direction, at 66b in the 180° direction, at 66c in the 270° direction and at 66d in the 90° direction. In FIGS. 7, weight 68 is depicted attached to headgear 60 in the 270° direction.

The center of mass of an attached free weight such as 68 is at a distance from vertical axis 28 of head 12 that is greater than the distance from vertical axis 28 of the ears.

Due to the material from which fashioned, both headgear 60 and weight 68 are waterproof. Being made of polyethylene, when weight 68 is not attached to headgear 60, headgear 60 floats on fresh water. The back 30 of headgear 60 is substantially the back portion of headband 14, thereby leaving the cervical spine of a wearer accessible and free of obstruction. Additionally, back 30 of headgear 60 protrudes by not more than the combined thickness of headband 14 and sagittal weight-supporting strap 62, i.e., 6 mm.

If desired, it is possible to attached detachable handles to headgear 60, for example, handles 22 described with reference to FIG. 1 and headgear 10. Such attachment allows combining the teachings herein relating to diagnosis and pain reduction with the teachings related to maintenance and physical improvement.

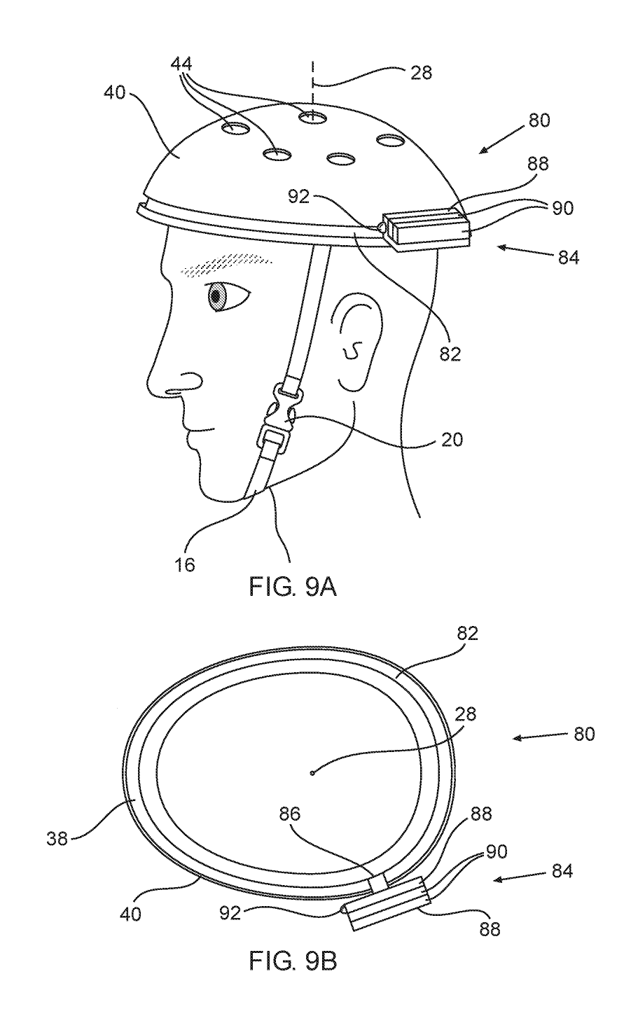

An embodiment of headgear according to the teachings herein, headgear 72, is schematically depicted in FIGS. 8 in side view (FIG. 8A) and top view (FIG. 8B) worn on the head 12 of a subject. Headgear 72 resembles headgear 36 discussed with reference to FIGS. 3 and shares many common features and components therewith that, for the sake of brevity will not be discussed in detail again. Headgear 72 is devoid of the aluminum rods 42 found in headgear 36. Headgear 72 comprises eight hollow aluminum plugs 74 each forming a keyhole attachment with a wide upper part and a narrow lower part, plugs 74 constituting the eight attachment loci of headgear 72, and which also perform the density-increasing function of aluminum rods 42.

Headgear 72 comprises a specially-configured free weight 76. Headgear 72 and free weight 76 and together are considered a headgear and weight kit according to the teachings herein. Weight 76 is an ovoid-shaped piece of lead covered with rubber weighing a total of 400 g that is specially configured to mate with aluminum plugs 74. Weight 76 includes a mushroom-headed stud 78 configured to reversibly engage the keyhole attachment formed by aluminum plugs 74. Specifically, the head of a stud 78 of a detached weight 76 is placed through broader upper portion of the gap in the face plate of an aluminum plug 74, into the void defined by the aluminum plug 74. The weight 76 is pushed downwards so that the head of stud 78 rests against the walls flanking the narrow lower portion of the gap in the face plate of the aluminum plug 74. In such a way, a weight 76 is attached to and supported substantially immovably on headgear 72 at one of eight positions of the transverse plane of headgear 72: at 74a in the 0° direction, at 74b in the 180° direction, at 74c in the 270° direction, at 74d in the 90° direction, at 74e in the 45° direction, at 74f in the 135° direction, at 74g in the 225° direction and at 74h in the 315° direction. In FIGS. 8, weight 76 is depicted attached to headgear 72 in the 0° direction.

Headgear 72 also comprises slip resistant areas 46, allowing implementation of the teachings herein relating to diagnosis and pain reduction.

Weight 76 has a fixed weight. In some related embodiments, a weight comprises a frame with a mushroom-headed stud 78 configured to reversibly engage the keyhole attachment formed by aluminum plugs 74 as described above. The weight is provided with a plurality of thin metal plates (e.g., of stainless steel, typically dimensions 10 cm high, 5 cm wide with a width that depends on the desired weight of the plate, each 1 mm thickness weighing about 40 gram). The frame is configured to carry a variable number of plates, allowing varying the amount of weight attached to the headgear.

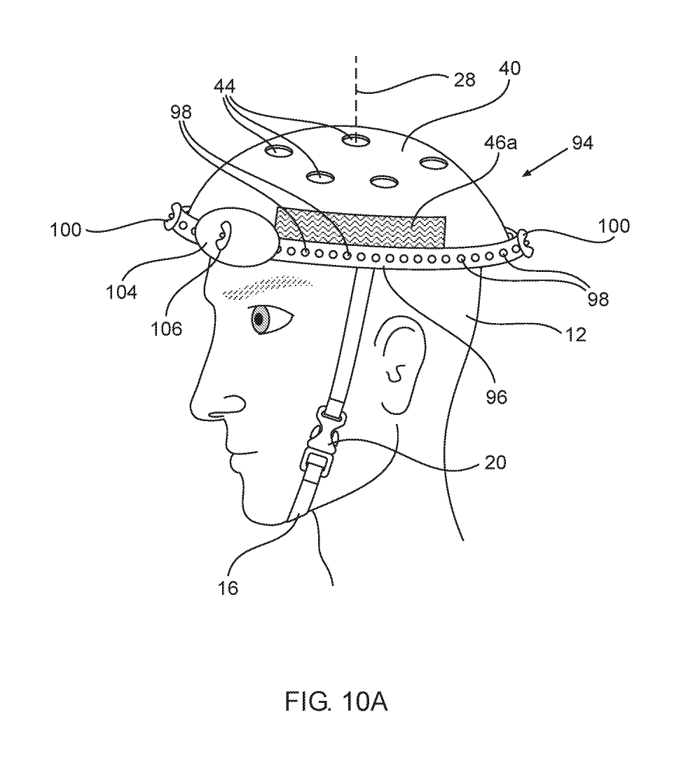

An embodiment of headgear according to the teachings herein, headgear 80, is schematically depicted in FIGS. 9 in side view (FIG. 9A) and top view (FIG. 9B) worn on the head 12 of a subject. Headgear 80 resembles headgear 36 discussed with reference to FIGS. 3 and shares many common features and components therewith that, for the sake of brevity will not be discussed in detail again.

Headgear 80 comprises a circumferential groove rail 82 made of aluminum embedded in the shell and underlying layer of headgear 80.

Headgear 80 comprises a single weight carriage 84 weighing 100 g (and therefore constituting a component weight) as a movable attachment locus, weight carriage 84 having an internal rail-riding portion 86 and an external weight-bearing portion 88.

Weight-bearing portion 88 is configured for attachment of one or more thin metal plates 90 (e.g., of stainless steel, typically dimensions 10 cm high , 5 cm wide with a width that depends on the desired weight of the individual plate 90, each 1 mm thickness weighing about 40 gram). Weight-bearing portion 868 is configured to carry a variable number of plates 90, allowing varying the amount of weight attached to headgear 80.

Rail-riding portion 86 is configured to fit in groove rail 82. When spring-loaded locking button 92 is depressed, brake teeth (not depicted) of rail-riding portion 86 are disengaged from the walls of groove rail 82, so that weight carriage 84 is in an adjusting state being movable to any position around headgear 80, including the four quadrant positions. When locking buttons 92 is released, weight carriage B is in a locked state where the brake teeth engage the walls of groove rail 82 so that weight carriage 84, and any plates 90 carried on weight-bearing portion 88, are substantially immovably located at the position.

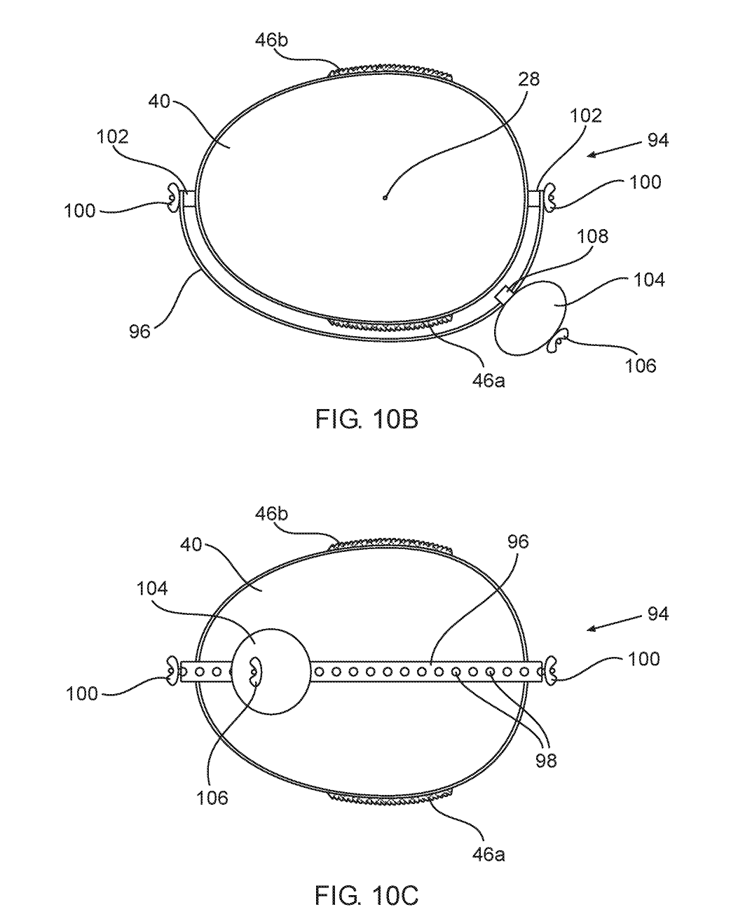

An embodiment of headgear according to the teachings herein, headgear 94, is schematically depicted in FIGS. 10 in side view (FIG. 10A) and two top views (FIGS. 10B and 10C) worn on the head 12 of a subject. Headgear 94 resembles headgear 36 discussed with reference to FIGS. 3 and headgear 80 discussed with reference to FIGS. 9 and shares many common features and components therewith that, for the sake of brevity will not be discussed in detail again.

Headgear 94 comprises a curved band 96 of aluminum with perforations 98 along the length thereof. Perforations 98 constitute movable attachment loci of headgear 94. Curved band 96 is movably secured to headgear 94 by wingbolts 100 that engage threads embedded in shell 40 and underlying layers of headgear 94. Offset sleeves 102 keep curved band at a distance of 2 cm away from the outer surface of shell 40. When wingbolts 100 are loose and therefore in an adjusting state, band 96 can be sagitally rotated (clockwise/counter clockwise around the face of a person wearing the headgear) around the axis defined by wingbolts 100. When wingbolts 100 are tightened and therefore in a locked state, band 96 is locked in place and further rotation is prevented.

Headgear 94 comprises a free weight 104 held in place at a desired position along curved band 96 by wingbolt 106 that engages bracket 108. When wingbolt 106 is loose and therefore in an adjusting state, weight 104 can be slid to any desired position along curved band. When wingbolt 106 is tightened and therefore in a locked state, weight 104 is locked in position, and cannot slide along curved band 96.

As is clear from the description and FIGS. 10A, 10B and 10C, headgear 94 is configured to substantially immovably support weight 104 in a plurality of positions in the transverse plane, including directions 0°, 90°, 180° and 270° (the four quadrant positions), as well as directions 45°, 135°, 225° and 315°.

Additionally, headgear 94 is configured to substantially immovably support weight 104 in a plurality of different locked states located at the same positions of the transverse plane of the headgear, but having a different elevation.

Some embodiments of a headgear similar to headgear 94 or a kit comprising as a headgear similar to headgear 94, include a plurality of different free weights such as 104 configured to attach to band 96, typically each such weight weighing a different amount. In some embodiments of a headgear similar to headgear 94 or a kit comprising as a headgear similar to headgear 94, include a carriage similar to carriage 84, configured to attach to band 96 and also configured to bear one or more loose weights analogous to plates 90.

Although the description herein has been primarily focused on human subjects suffering from cervical disorders, the teachings herein are useful for diagnosis, pain reduction, physical improvement and maintenance for subjects suffering from other disorders.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A method for hydrotherapeutic treatment of a human subject in need thereof, the human subject wearing a headgear, comprising:
while the head of the subject is at least partially immersed in water,
a. maintaining the nose and mouth of the subject outside of the water to a degree allowing breathing; and
b. moving the head of the subject to effect diagnosis and therapy of the neck of the subject,
wherein said moving of the head is by a treating person who moves the head through said headgear.

2. The method of claim 1, wherein said treating person applies a force that moves the head through said headgear by contacting said headgear with one or two hands of the treating person.

3. The method of claim 1, wherein said moving of the head of the subject is at least one of:
i. rotating the head of the subject around the cervical axis in the transverse plane;
ii. sagittal flexion of the neck of the subject by bending the neck back and forth in the sagittal plane);
iii. side flexion of the neck of the subject by bending the neck left and right in the frontal plane);
iv. pulling the head of the subject in the vertical axis; and
v. combinations of i, ii, iii and iv.

4. The method of claim 1, wherein during said immersion, the subject is laying face-up in the water.

5. The method of claim 1, wherein during said immersion, the subject is laying on the side in the water.

6. The method of claim 1, wherein during said immersion, the subject is laying face-down in the water.

7. The method of claim 1, wherein during said immersion, the subject is floating in the water.

8. The method of claim 7, wherein the subject is functionally associated with a flotation aid.

9. A method of performing hydrotherapy on a human subject in need thereof, comprising:
a. immersing at least part of the body of a human subject in water; and
b. while the at least part of the body is immersed in the water, moving the head of the subject while an artificial free weight is affixed to the head in a fixed asymmetric distribution.

10. The method of claim 9, wherein during said immersion, the subject is laying face-up in the water.

11. The method of claim 9, wherein during said immersion, the subject is laying on the side in the water.

12. The method of claim 9, wherein during said immersion, the subject is laying face-down in the water.

13. The method of claim 9, wherein during said immersion, the subject is floating in the water.

14. The method of claim 9, wherein said artificial weight that is affixed to the head is borne on a headgear worn by the subject.

15. The method of claim 9, the moving is at least one of:
i. rotating the head of the subject around the cervical axis in the transverse plane;
ii. sagittal flexion of the neck of the subject by bending the neck back and forth in the sagittal plane;
iii. side flexion of the neck of the subject by bending the neck left and right in the frontal plane;
iv. pulling the head of the subject in the vertical axis; and
v. combinations of i, ii, iii and iv.

16. The method of claim 9, further comprising during the moving the head, changing said fixed asymmetric distribution from a preceding fixed asymmetric distribution to a different succeeding fixed asymmetric distribution.

17. The method of claim 9, wherein said artificial weight is fixed so that, when the subject stands with said weight in said asymmetric distribution, said weight applies a downwards tilting force to the head.

18. The method of claim 9, wherein a center of mass of said artificial weight is not less than 3 cm from the surface of the head of the subject.

19. A headgear suitable for use in hydrotherapy, comprising:
a head encircler configured to encircle the head of a human around the skull;
a chin strap functionally associated with said head encircler, configured to encircle the head of a human underneath the chin,
said head encircler and said chin strap together configured to immovably secure the headgear to the head of a human wearer, and
the headgear configured for substantially immovable support of an attached free weight of at least 100 g through at least one attachment locus at at least four quadrant positions of the transverse plane of the headgear one at a time:
i. a front position where a center of mass of a said attached weight is located towards the front of the headgear in a direction within 30° of the 0° direction of the transverse plane;
ii. a right position where the center of mass of a said attached weight is located towards the right of the headgear in a direction within 30° of the 90° direction of the transverse plane;
iii. a back position where the center of mass of a said attached weight is located towards the back of the headgear in a direction within 30° of the 180° direction of the transverse plane; and
iv. a left position where the center of mass of a said attached weight is located towards the left of the headgear in a direction within 30° of the 270° direction of the transverse plane.
functionally associated with said head encircler, one or both of:
at least two handles, each located on a different one of two sides of the headgear, configured for engagement by the hands of a human located along a vertical axis of the headgear; and
a shell, functionally associated with said head encircler, configured to at least partially surround the skull of a human wearing the headgear, with a slip resistant area on each one of two sides of said shell, a slip resistant area configured for non-sliding contact with a naked human hand when wet,
wherein the headgear is waterproof.

20. A kit suitable for use in hydrotherapy, comprising:
a headgear of claim 19; and
at least one free weight, attachable to said headgear through at least one said attachment locus.
